(19) United States
(12) Patent Application Publication
(10) Pub. No.: US 2022/0126434 A1
(43) Pub. Date: Apr. 28, 2022

(54) Staple Holding Device

(71) Applicant: Mark Avalone, Webster, NY (US)

(72) Inventor: Mark Avalone, Webster, NY (US)

(21) Appl. No.: 17/506,791

(22) Filed: Oct. 21, 2021

Related U.S. Application Data
(60) Provisional application No. 63/105,504, filed on Oct. 26, 2020.

(51) Int. Cl. B25C 3/00

(52) U.S. Cl. CPC B25C 3/006; G09F 23/00

(57) ABSTRACT

The present invention relates generally to the field of staples. More specifically, the present invention relates to a staple holding device. The device is comprised of a body that has a first end, a second end and a removable handle. In the preferred embodiment, the body is generally rectangular in shape such that it can be easily gripped by a user. The body is further comprised of at least one cutout, wherein the cutout has a channel that receives the body of a staple. The staple is further secured within the channel such that the body and/or the handle can be struck by a hammer in order to allow the staple to be secured within a surface at a specific depth.

### CROSS-REFERENCE TO RELATED APPLICATION

The present application claims priority to, and the benefit of, U.S. Provisional Application No. 63/105,504, which was filed on Oct. 26, 2020 and is incorporated herein by reference in its entirety.

### FIELD OF THE INVENTION

The present invention relates generally to the field of staples. More specifically, the present invention relates to a staple holding device. The device of is comprised of a body that has a first end, a second end and a removable handle. In the preferred embodiment, the body is generally rectangular in shape such that it can be easily gripped by a user. The body is further comprised of at least one cutout, wherein the cutout has a channel that receives the body of a staple. The staple is further secured within the channel such that the body and/or the handle can be struck by a hammer in order to allow the staple to be secured within a surface at a specific depth. Accordingly, the present disclosure makes specific reference thereto. Nonetheless, it is to be appreciated that aspects of the present invention are also equally applicable to other like applications, devices and methods of manufacture.

### BACKGROUND

Generally U-shaped staples are regularly used in the construction industry in order to secure wiring in various positions to studs, rafters, walls, joists, etc. This process is typically done by holding a staple in one hand, positioning the legs of the staple around the wiring and on the surface the staple is being driven into, and then driving the staple into the surface using a hammer in the other hand. However, imprecise usage of the hammer may result in an individual hammering his or her own hand, which is painful and can lead to serious injury. Further, the staple may fall out of the hand of the user and then must be picked up, which is also undesirable and time-consuming. In addition, a user may hammer the staple too hard such that the staple crushes the wire or the legs of the staple.

Therefore, there exists a long-felt need in the art for a device that allows a user to more efficiently and safely secure staples to a surface. There also exists a long-felt need in the art for a staple holding device that does not require a user to hold a staple in position with his or her hand while attempting to drive the staple into a surface, thereby eliminating the possibility of the user accidentally striking his or her hand. Further, there exists a long-felt need in the art for a staple holding device that allows a user to drive a staple at a consistent depth, such that the staple does not crush any wiring or damage the surface the staple is being driven in to. Finally, there exists a long-felt need in the art for a staple holding device that prevents a staple from being easily dropped when being held into position in anticipation of being driven into a surface.

The subject matter disclosed and claimed herein, in one embodiment thereof, comprises a staple holding device. The device of is comprised of a body that has a first end, a second end, and a removable handle. In the preferred embodiment, the body is generally rectangular in shape such that it can be easily gripped by a user. The body is further comprised of at least one cutout, wherein the cutout has a channel that receives the body of a staple. The staple is further secured within the channel such that the body and/or the handle can be struck by a hammer in order to allow the staple to be secured within a surface at a specific depth.

In this manner, the staple holding device of the present invention accomplishes all of the forgoing objectives and allows a user to more efficiently and safely secure staples to a surface, while also not requiring that a user holds a staple in position with his or her hand while attempting to drive the staple into a surface. As a result, the device eliminates the possibility of the user accidentally striking his or her hand. Further, the device allows a staple to be driven into a surface at a consistent depth, such that the staple does not crush any wiring or damage the surface, and also prevents a staple from being easily dropped when being held into position in anticipation of being driven into a surface. In this manner, the staple holding device overcomes the limitations of existing methods of holding and securing staples known in the art.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a staple holding device. The device is further comprised of a body that has a first end, a second end and a removable handle. In the preferred embodiment, the body is generally rectangular in shape such that it can be easily gripped by a user. But, in differing embodiments the body may also be of a cylindrical or other shape. In addition, the body is preferably made from a durable metal. Further, any surface of the body may have a plurality of indicia.

The first end of the body is further comprised of at least one cutout. The cutout is preferably shaped like half of a square, and has two 90-degree angles. In differing embodiments, the cutout may be located on any portion, surface, area or location of the body such as, but not limited to, adjacent to the first end or second end. In addition, one embodiment of the device may have a plurality of cutouts. The cutout has a channel that receives the cross member and both legs of an industrial, residential and/or commercial staple. In differing embodiments, the channel may contact all sides of the staple and ensure the staple remains in an upright and stable position. However, in various embodiments the channel may be located only on the rear surface of the cutout and/or only on the interior surface of each protrusion formed by the cutout.

Once a staple has been placed within the channel, the first end (or in an embodiment wherein the channel is located elsewhere on the body, said portion of the body) can be positioned against a surface such that the protrusions contact the surface. Then, the second end can be struck by a hammer or other tool of the like in order to drive the staple into the surface. In differing embodiments which have cutouts located on various portions of the body, any surface of the body may be struck by a hammer in this fashion to achieve said result. Further, the protrusions formed by the cutout only allow the staple to be driven into the surface until it has reached a specific depth. Therefore, the device allows a user to hammer staples at a consistent depth, and therefore prevents the staples from crushing any wiring that they are being installed around or being used to secure.

The device may also be comprised of a removable handle that is comprised of male protrusion that has a plurality of male threads. The male threads then engage a plurality of female threads located within at least one continuous opening located on any surface of the body. While attached to the body the handle can be used in a fashion similar to a punch, wherein any surface of the handle (but preferably the top surface) can be struck by a hammer to drive the staple into a surface instead of or in addition to the second end. Further, in one embodiment a user may grip the handle and use the handle to swing the device in a hammer-like motion to use the device itself to drive the staple into a surface.

Accordingly, the staple holding device of the present invention is particularly advantageous as it allows a user to more efficiently and safely secure staples to a surface. The device also does not require a user to hold a staple in position with his or her hand while attempting to drive the staple into a surface. As a result, the device eliminates the possibility of the user accidentally striking the hand. Further, the device allows a staple to be driven into a surface at a consistent depth, such that the staple does not crush any wiring or damage the surface. Finally, the device prevents a staple from being easily dropped when being held into position in anticipation of being driven into a surface. In this manner, the staple holding device overcomes the limitations of existing methods of holding and securing staples known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top perspective view of one potential embodiment of a staple holding device of the present invention in accordance with the disclosed architecture;

FIG. 2A illustrates a front perspective view of one potential embodiment of a staple holding device of the present invention in accordance with the disclosed architecture;

FIG. 2B illustrates a front perspective view of one potential embodiment of a staple holding device of the present invention in accordance with the disclosed architecture;

FIG. 3 illustrates a perspective view of one potential embodiment of a staple holding device of the present invention while a staple (shown as prior art) is within the device in accordance with the disclosed architecture;

FIG. 4 illustrates a perspective view of a plurality of potential embodiments of a staple holding device of the present invention in accordance with the disclosed architecture; and

FIG. 5 illustrates a bottom perspective view of one potential embodiment of a staple holding device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that allows a user to more efficiently and safely secure staples to a surface. There also exists a long-felt need in the art for a staple holding device that does not require a user to hold a staple in position with his or her hand while attempting to drive the staple into a surface, thereby eliminating the possibility of the user accidentally striking the hand. Further, there exists a long-felt need in the art for a staple holding device that allows a user to drive a staple at a consistent depth, such that the staple does not crush any wiring or damage the surface the staple is being driven in to. Finally, there exists a long-felt need in the art for a staple holding device that prevents a staple from being easily dropped when being held into position in anticipation of being driven into a surface.

The present invention, in one exemplary embodiment, is comprised of a staple holding device. The device is comprised of a body that has a first end, a second end and a removable handle. In the preferred embodiment, the body is generally rectangular in shape such that it can be easily gripped by a user. The body is further comprised of at least one cutout. The cutout has a channel that receives the body of a staple. The staple is further secured within the channel such that the body and/or the handle can be struck by a hammer in order to allow the staple to be secured within a surface at a specific depth.

Accordingly, the staple holding device of the present invention is particularly advantageous as it allows a user to more efficiently and safely secure staples to a surface. The device also does not require a user to hold a staple in position with his or her hand while attempting to drive the staple into a surface. As a result, the device eliminates the possibility of the user accidentally striking the hand. Further, the device allows a staple to be driven into a surface at a consistent depth, such that the staple does not crush any wiring or damage the surface. Finally, the device prevents a staple from being easily dropped when being held into position in anticipation of being driven into a surface. In this manner, the staple holding device overcomes the limitations of existing methods of holding and securing staples known in the art.

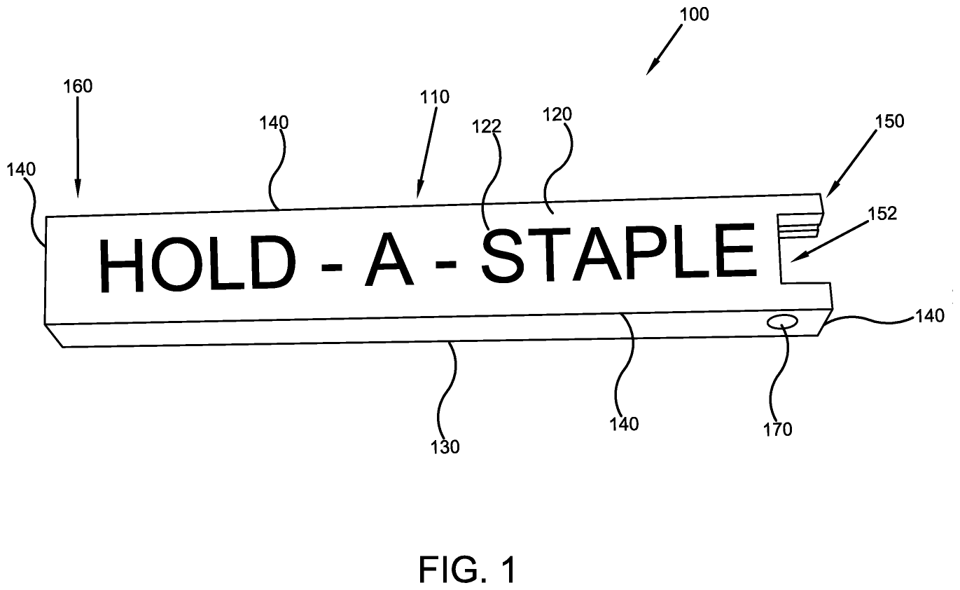

Referring initially to the drawings, FIG. 1 illustrates a top perspective view of one potential embodiment of a staple holding device 100 of the present invention in accordance with the disclosed architecture. The device 100 is comprised of a body 110 that is further comprised of a first end 150, a second end 160 and a removable handle 180. In the preferred embodiment, the body 110 is generally rectangular in shape, such that it can be easily gripped by a user. However, in differing embodiments the body 110 may be round, cylindrical or any other shape known in the art. The body 110 is further manufactured from a magnetic or non-magnetic, durable metal, such as but not limited to stainless steel or aluminum. However, in one embodiment the body 110 may be manufactured from a rigid, impact resistant plastic material such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. The body 110 is also comprised of a top surface 120 and a generally parallel bottom surface 130, as well as a first set and a second set of generally parallel side surfaces 140. Any surface 120,130,140 may further be comprised of a plurality of engraved, painted, stickered, or embossed indicia 122 such as but not limited to: patterns, logos, emblems, images, symbols, designs, letters, words, characters, animals, advertisements, brands, etc.

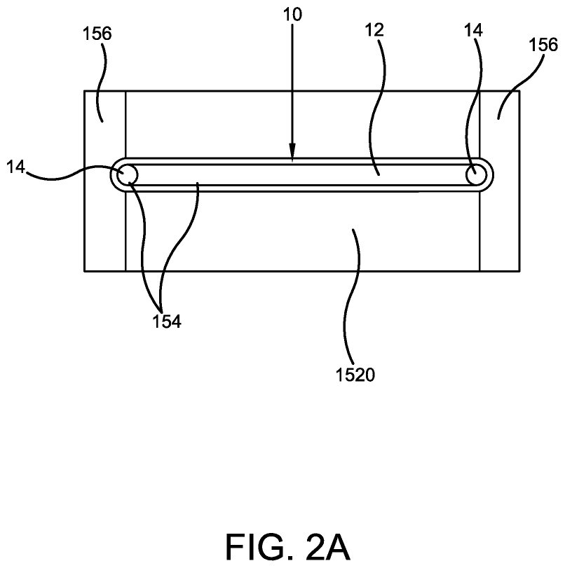

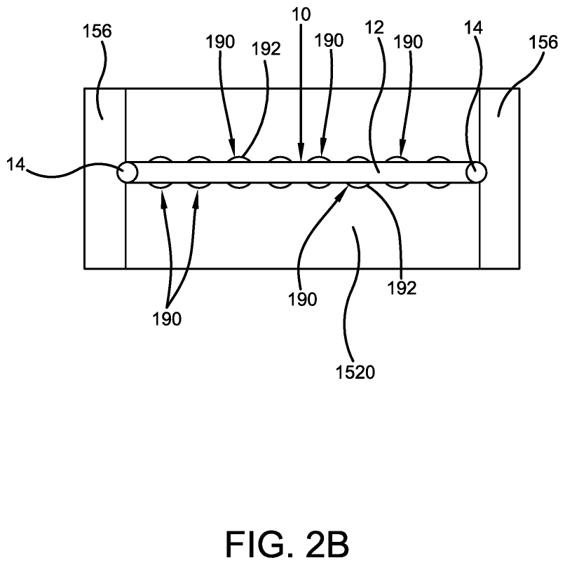

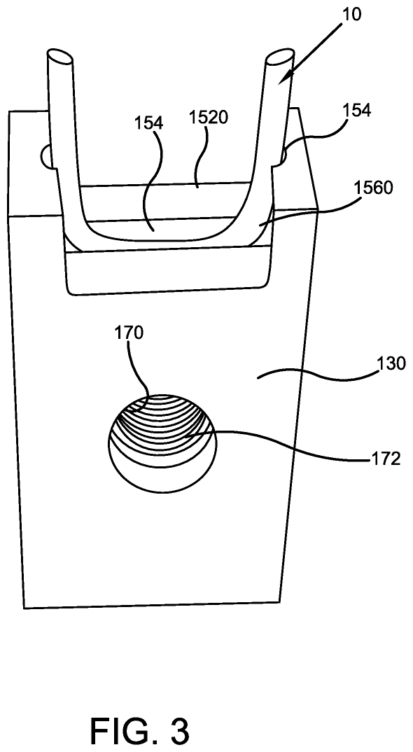

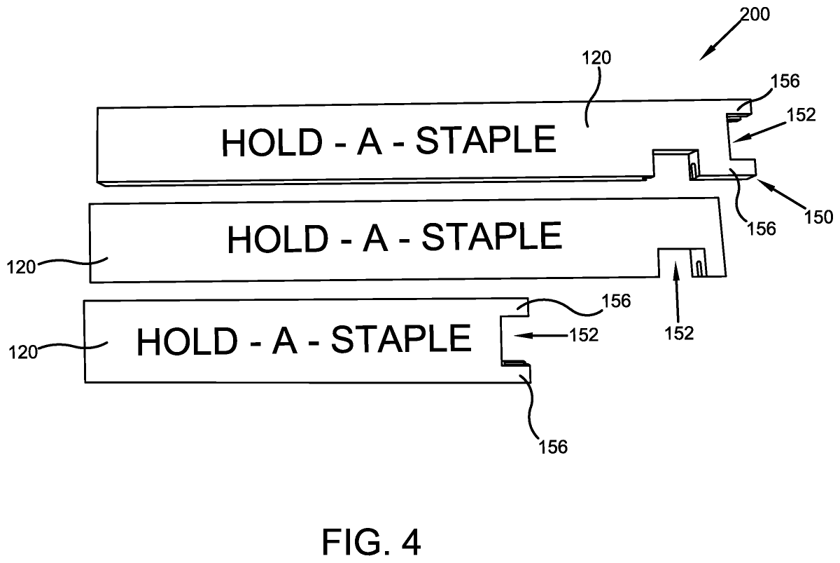

The first end 150 of the body 110 is further comprised of at least one cutout 152 that is preferably shaped like half of a square, and has two 90-degree angles. However, in differing embodiments the cutout 152 may be any shape known in the art such as, but not limited to, rectangular, circular, oblong, triangular, etc. Further, in differing embodiments the cutout 152 may be located on any portion, surface, area, or location of the body 110 such as, but not limited to, adjacent to the first end 150 or second end 160, as shown in FIG. 4. In addition, one embodiment of the device 100 may have a plurality of cutouts 152. The cutout 152 is further comprised of a channel 154 that receives the cross member 12 and both legs 14 of an industrial, residential and/or commercial staple 10, as best seen in FIG. 2A and FIG. 3. It should be noted that in one embodiment, the channel 152 contacts all sides of the staple 10 and ensures the staple 10 remains in an upright and stable position. In an embodiment of the body 110 that is magnetic, the channel 154 may also be magnetic to aid in retaining the staple 10 within the channel 154. However, in differing embodiments, the channel may be located only on the rear surface 1520 of the cutout 152 and/or only on the interior surface 1560 of each protrusion 156 that may be formed by the cutout 152 in one (but not all) embodiments of the device 100. The device 100 may alternatively or additionally be comprised of a plurality of circular openings or cutouts 190, wherein said cutouts 190 may be located on the rear surface 1520 of the cutout 152 in lieu of or in addition to the channel 154, as seen in FIG. 2B. Additionally, when the body 110 itself is not magnetic, magnets 192 may be positioned in one or more of the cutouts 190 to hold the staple in place prior to installation, as also shown in FIG. 2B.

Once a staple 10 has been placed within the channel 154, the first end 150 (or in an embodiment wherein the channel 154 is located elsewhere on the body 110, said portion of the body) can be positioned against a surface 20 (such as but not limited to, a piece of wood) such that the protrusions 156 contact the surface 20. Then, the second end 160, and more specifically the side surface 140 of the second end 160, in an embodiment of the device 100 with a cutout 152 on the first end 150, can be struck by a hammer 22 or other tool of the like, in order to drive the staple 10 into the surface 20. However, it should be appreciated in that in differing embodiments which have cutouts 152 located on various portions of the body 110, any surface 120, 130, 140 of the body 110 may be struck by a hammer 22 in this fashion to achieve said result. It should also be appreciated that the protrusions 156 of the side surface 140, top surface 120 and bottom surface 130, which are formed by the cutout 152 only allow the staple 10 to be driven into the surface 20 until it has reached a specific depth. This depth is achieved by the overall length of the protrusions 156 and the size (e.g. length and width) of the cutout 152, which prevent the device 100 itself from being driven into the surface 20. In this manner, the device 100 allows a user to hammer staples 10 at a consistent depth, and therefore prevents the staples 10 from crushing any wiring (not shown) that they are being installed around or being used to secure. It should be appreciated that in differing embodiments, the size/depth of the cutout 152 and channel 154 may differ to create a plurality of differing depths, and/or accept a plurality of residential, commercial and/or industrial staple sizes known in the art. One embodiment of the device 100 may include a kit 200 comprised of a plurality of devices 100 of varying cutout 152 and/or channel 154 depths to accommodate a wide variety of commercial, industrial and/or residential staples 10 known in the art.

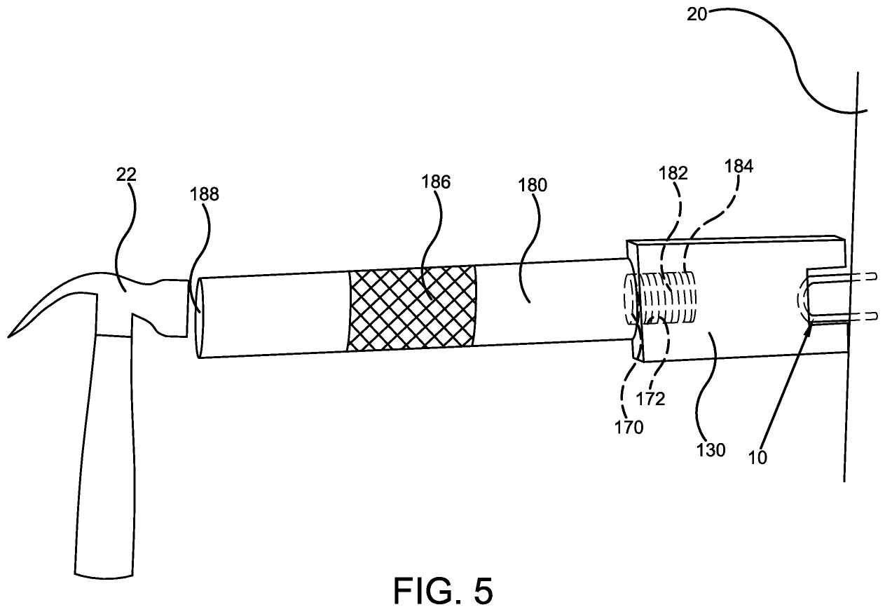

FIG. 5 illustrates a bottom perspective view of one potential embodiment of a staple holding device 100 of the present invention in accordance with the disclosed architecture. In addition to striking the second end 160 to drive a staple 10 into a surface 20 using the device 100, the device 100 may also be comprised of a removable handle 180. The handle 180 is preferably cylindrical, but may also be square or rectangular, and is preferably comprised of the same material as the body 110. The handle 180 is also comprised of a male protrusion 156 that has a plurality of male threads 184. The male threads 184 then engage a plurality of female threads 172 located within at least one semi-continuous opening 170 located on the body 110. In differing embodiments, the body 110 may have at least one of said continuous openings 170 on the top surface 120, bottom surface 130, and/or side surfaces 140 in order to accommodate a wide variety of hammering positions and jobsite scenarios. Accordingly, while attached to the body 110 the handle 180 can be used in a fashion similar to a punch, wherein any surface of the handle 180 (but preferably the top surface 188) can be struck by a hammer 22 to drive the staple 10 into a surface 22 instead of or in addition to the second end 160. Further, in one embodiment a user may grip the handle 180 and use the handle 180 to swing the device 100 in a hammer-like motion to use the device 100 itself to drive the staple 10 into a surface 22. This embodiment may also feature a textured rubber or metal grip 186 to prevent the device 100 from slipping out of the hand of a user.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “staple holding device” and “device” are interchangeable and refer to the staple holding device 100 of the present invention.

Notwithstanding the forgoing, the staple holding device 100 of the present invention and its various components can be of any suitable size and configuration as is known in the art without affecting the overall concept of the invention, provided that they accomplish the above-stated objectives. One of ordinary skill in the art will appreciate that the size, configuration and material of the staple holding device 100 as shown in the FIGS. are for illustrative purposes only, and that many other sizes and shapes of the staple holding device 100 are well within the scope of the present disclosure. Although the dimensions of the staple holding device 100 are important design parameters for user convenience, the staple holding device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A staple holding device comprising:
a body comprised of:
a top surface;
a bottom surface;
a first set of generally parallel side surfaces;
a second set of generally parallel side surfaces; and
at least one cutout that is further comprised of a channel; and
a handle removably attached to the body.

2. The staple holding device of claim 1, wherein the channel further comprises at least one magnet and is sized and configured to receive a staple.

3. The staple holding device of claim 2 further comprising a hammer, wherein the body can be struck by the hammer in order to drive the staple into a surface.

4. The staple holding device of claim 3, wherein the at least one cutout has a size and a configuration that allows the staple to be driven into the surface at a consistent depth.

5. A staple holding device used to drive a staple into a surface at a consistent depth, the staple holding device comprising:
a body comprised of:
at least one semi-continuous opening comprised of a plurality of female threads;
a top surface;
a bottom surface;
a first set of generally parallel side surfaces;
a second set of generally parallel side surfaces; and
at least one cutout having a pair of 90-degree angles and a pair of protrusions that is further comprised of a channel that is sized and configured to receive a staple; and
a removable handle having a protrusion that is further comprised of a plurality of male threads; and
a plurality of indicia positioned along the body.

6. The staple holding device of claim 5 further comprising a hammer, wherein a staple is positioned within the channel and the body is struck by the hammer in order to drive the staple into the surface at the consistent depth.

7. The staple holding device of claim 5 further comprising a hammer, wherein a staple is positioned within the channel and the removable handle is struck by the hammer in order to drive the staple into the surface at the consistent depth.

8. A staple holding device comprising:
a body comprised of:
at least one semi-continuous opening comprised of a plurality of female threads;
a top surface;
a bottom surface;
a first set of generally parallel side surfaces;
a second set of generally parallel side surfaces;
a cutout with a pair of 90-degree angles and a pair of protrusions that is further
comprised of a channel that is sized and configured to receive a staple;
a removable handle having a protrusion that is comprised of a plurality of male threads that engage with the plurality of female threads of the at least one semi-continuous opening;
a plurality of indicia located on the body; and
a hammer.

9. The staple holding device of claim 8, wherein the staple is positioned within the channel and the body is struck by the hammer in order to drive the staple into a surface at a consistent depth.

10. The staple holding device of claim 8, wherein the staple is positioned within the channel and the removable handle is struck by the hammer in order to drive the staple into a surface at a consistent depth.

11. The staple holding device of claim 8, wherein the body comprises a select one of a rectangular shape or a cylindrical shape.

12. The staple holding device of claim 8, wherein the body is comprised of a magnetic metal.

13. The staple holding device of claim 8, wherein the plurality of indicia is at least two of a pattern, a logo, an emblem, an image, a symbol, a design, a letter, a word, a character, an animal, an advertisement and a brand.

14. The staple holding device of claim 8, wherein the at least one cutout is located on a first end of the body.

15. The staple holding device of claim 8, wherein the at least one cutout is located adjacent to a first end of the body and on the first set of generally parallel side surfaces or the second set of generally parallel side surfaces.

16. The staple holding device of claim 8, wherein when attached to the body, the removable handle can be used to swing the staple holding device in a hammer-like motion in order to drive the staple positioned within the channel into a surface.

17. The staple holding device of claim 8, wherein the channel contacts all exterior sides of the staple to ensure the staple remains in an upright and stable position.

18. The staple holding device of claim 8, wherein the channel is located on a rear surface of the cutout.

19. The staple holding device of claim 8, wherein the channel is located on an interior surface of the pair of protrusions.

20. The staple holding device of claim 8, wherein the channel is located on a rear surface of the cutout and on an interior surface of the pair of protrusions.
